(19) United States
(12) Patent Application Publication
(10) Pub. No.: US 2007/0167341 A1
(43) Pub. Date: Jul. 19, 2007

(54) Chemical composition and uses

(75) Inventors: Diane Joyce Burt, Montvale, NJ (US); Mark Coke, East Lothian (GB); Dilip Shanker Mathur, East Brunswick, NJ (US); Andrew Thomson, Hull (GB)

Correspondence Address: NORRIS, MCLAUGHLIN & MARCUS, 875 THIRD AVE, 18TH FLOOR, NEW YORK, NY, 10022, US

(73) Assignee: RECKITT BENCKISER (UK) LIMITED, Slough, Berkshire (GB)

(21) Appl. No.: 10/598,711

(22) PCT Filed: Mar. 17, 2005
(86) PCT No.: PCT/GB05/01043

§ 371 Date: Jan. 23, 2007

(30) Foreign Application Priority Data
Mar. 25, 2004 (GB) 0406720.3

(51) Int. Cl. C11D 17/04

(52) U.S. Cl. 510/277

(57) ABSTRACT

A product comprising separate compartments, contains first and second components of a composition and a catalyst for a reaction between the two components. In use, the two components are combined together to form the composition, preferably a cleaning composition, whose temperature is elevated when compared to the temperature of the components prior combination, providing improved performance. Method of manufacture, method of cleaning a surface, a kit, and an applicator means are disclosed.

This invention relates to chemical compositions; in particular, but not exclusively, to cleaning products and their uses in methods of cleaning.

It is known that over a wide array of cleaning operations, improved results are obtained when the operation is carried out at elevated temperatures. Hence, warm water rather than cold water, is often used. Aside from such cleaning benefits, the feeling of warmth gives the user of the cleaning product reassurance that effective cleaning is taking place. It also makes the cleaning operation more pleasant to carry out. It also leads to increased rate of chemical reactions. Nevertheless, it is not always possible to have ready access to a convenient source of warm water when cleaning.

It would therefore be of benefit to provide a cleaning product comprising a composition comprising a plurality of components, initially kept separate from each other, which when mixed together react and give out heat, such that the composition thus formed is at an elevated temperature compared to the temperature of the individual components of the composition. As a consequence, the environment of any surface to which the composition, or the components of the composition, is/are applied will have its temperature increased by such application. It is therefore an object of the present invention to provide such compositions.

It would also be advantageous to provide a composition at an elevated temperature which can be applied directly onto the surface to be treated or cleaned without the need for a substrate, or the like. The use of such substrates, such as cleaning substrates e.g. fibrous materials, and the like, can exhibit disadvantages because there is the risk of spillage when applying the composition to the substrate, or overloading the substrate. Moreover, there is the risk that the user's hands may become coated with the composition during application of the composition to the substrate. It is therefore a further object of the present invention to provide compositions which can be applied directly to the surface to be treated, thus providing an elevated temperature directly onto the surface itself, rather than via a substrate. A further advantage is that any temperature rise when forming the composition will be more directly effective on the surface to be treated, rather than being effective on the substrate which is then applied to the surface. In other words, application of the composition, or the components of the composition, directly to the surface to be treated will avoid the need to heat the cleaning substrate by, for example, immersing it in warm water before using the substrate. For these purposes it is desirable to have a composition which heats rapidly once applied directly to the surface to be treated or cleaned, such that the user does not have to wait before starting the treating or cleaning process.

It would also be advantageous to provide a composition comprising a plurality of components, initially kept separate from each other, which when mixed together, react and undergo an exothermic reaction to give out heat, and form a composition which exhibits a final pH value enabling said composition to be safely handled by the user and enabling said composition to be effective in cleaning operations. It is therefore a yet further object of the present invention to provide such compositions.

Therefore, there remains the need to provide compositions, particularly cleaning compositions formed within cleaning products, that comprise initially separated components, which, when these components are mixed or come together, form a composition at an elevated temperature compared to the components themselves, where the elevated temperature is attained shortly after the components are mixed or come together, and with a pH value in a range suitable to be handled directly by the user, which do not require the presence of a separate cleaning substrate such as a fibrous material, and wherein each separate component is in a ready-to-use form, i.e. is already diluted or dispersed to the required concentration in the component itself such that no further dispersion, dilution or dissolution is required. In other words, the actual mixing of the initially-separated components of the composition provides a composition exhibiting the above properties.

US patent application 2003/0114340 (Ajamani & Chung) disclosed a composition comprising three liquids, for cleaning drains or hard surfaces, which are separately maintained prior to forming an admixture during delivery to a surface to be treated, whereupon the admixture generates a heated foam sufficient for cleaning efficacy and stability. The first liquid preferably includes a hypohalite, the second preferably a peroxygen agent and the third a reducing agent such as thiosulphate.

Patent GB 1308565 (The Gillette Company) discloses a self-heating pharmaceutical or cosmetic composition comprising first and second heat-generating components maintained separately from one another which effect an exothermic reaction when in contact.

According to the present invention there is provided a product, a method of manufacturing a cleaning product, a method of providing a cleaning composition, a method for the treatment of a surface, and the use of a composition, as set forth in the appended claims. Moreover, there is provided a kit, and an applicator means as described and defined herein.

Thus, according to a first aspect of the invention there is provided a product comprising separate first and second compartments, the first compartment containing a first component of a composition in a stable environment, the second compartment containing a second component of the composition in a stable environment, wherein one of the components comprises a catalyst for a reaction between the first and second components, wherein, in use, the said two components are combined together to form said composition, and wherein the temperature of said composition is elevated when compared to the temperature of the components prior to said combination.

Preferably, the product is a cleaning product and in this embodiment, the first and second components are components of a cleaning composition, such that in use, a cleaning composition is formed wherein the temperature of said composition is elevated when compared to the temperature of the components prior to said combination.

By “stable environment” we preferably mean that each component within each compartment of the product does not degrade or otherwise deteriorate to an appreciable extent or become unviable over a time period representing a reasonable shelf-life for cleaning products and the like, e.g. 0.5-2 years or so, at ambient conditions.

Suitably, the temperature of the composition is elevated when compared to the temperature of the components prior to said combination, preferably said temperature is elevated by at least 5^{O}C, more preferably at least 10^{O}C, yet more preferably at least 20^{O}C, even more preferably at least 25^{O}C, more preferably at least 30^{O}C, most preferably at least 40^{O}C. Preferably, these elevated temperatures are still exhibited at least 30 secs after the components are mixed, more preferably at least 60 secs, even more preferably at least 120 secs, yet even more preferably at least 180 secs, most preferably at least 240 secs after the components are mixed. Preferably, these elevated temperatures are first exhibited within 120 secs of mixing said components, more preferably within 60 secs of mixing, yet more preferably within 30 secs of mixing, yet more preferably within 15 secs of mixing, most preferably immediately the components are mixed, or shortly thereafter, i.e. within about 10 secs of mixing.

Preferably, the temperature of the composition is elevated by at most 60^{O}C, more preferably at most 55^{O}C, most preferably at most 50^{O}C. Suitably, if there is the possibility of the composition contacting the user, the temperature is elevated to a temperature which allows the user to touch the composition without scalding, and so a temperature increase of at most 40° C., preferably at most 30° C., even more preferably at most 25° C. is appropriate. In order for an appreciable effect to be achieved, the temperature rise is suitably at least 5° C., preferably at least 10C, more preferably at least 20° C.

Suitably, the first and second components of the product of this aspect of the present invention are mixed simply by adding the two components together. The mixing can be performed either directly on the surface to be treated, or alternatively, the two components can be mixed before the product is required for use and then added pre-mixed to the surface. In the latter case, the mixed components should be added to the surface whilst the beneficial elevated temperature properties of the product are still evident.

It has surprisingly been found that products as defined above exhibit improved properties, for example improved cleaning properties, compared to conventional products wherein the two components are not mixed directly on the surface or are not mixed just before adding the product to the surface and where there is no or only minimal temperature elevation.

Suitably, the components of the product are such that when the components mix, the temperature of the product thus formed is elevated compared to the temperature of the components. As noted above, this increase in temperature provides beneficial effects to the user of the product, both in improved performance of the product, particularly improved cleaning performance, and improved conditions for the user, in that the cleaning operation becomes more pleasant to carry out. The increase in temperature also means that the skin of the user, through direct or indirect contact with the mixed composition, may be pleasantly warmed.

One further advantage of the products of the present invention is that no separate cleaning substrate such as a tool, wipe or cloth is required, upon which the components of the product are mixed and which then carries the composition thus formed. As such, the product of the present invention can advantageously be added directly to the surface to be treated, at which point a substrate can be used, if desired, for subsequent wiping.

Moreover, there is no need to heat the substrate or add hot or warm water to the substrate to provide a heating effect. On the contrary, the elevated temperature is provided by the mixing of the components of the composition themselves and the consequent reaction between the components in the presence of the catalyst.

Thus, preferably, the product does not contain a cleaning substrate, such as a pad, wipe, mat or sponge. However, in another embodiment of the invention, the product may be supplied with an integrated substrate upon which the compositions are combined prior to application to a surface.

A yet further advantage of the present invention is that both components can be pre-formulated, i.e. made up in a ready-to-use form. As such, the user need simply cause the two components of the composition to mix to provide the composition with the beneficial properties described herein. Specifically, there is no requirement for the components to be dispersed and/or diluted in a carrier medium, e.g. water, mains water.

The term “cleaning” as used herein may include the following: removal of soil deposits; removal of greasy deposits or stains; de-scaling; bleaching; and the combating of microbes (including mould) or allergens, including by one or more of antiseptic, disinfectant and bactericidal action.

Thus, cleaning may be by one or more of antiseptic, disinfectant, and biocidal action, as well as what may be termed “regular” cleaning, for example of common household surfaces such as kitchen worktops, sanitaryware surfaces, hard floors and textile surfaces.

Indeed, by “surface” we mean and include, preferably, inanimate surfaces, including non-dermal surfaces. We include both hard and soft surfaces.

By “hard surface”, we include ceramics, glass, stone, plastics, marble, metal and/or wood surfaces, such as, in the household environment for example, bathroom and kitchen hard surfaces such as sinks, bowls, toilets, drains, panels, tiles, worktops, dishes, floors, and the like.

By “soft surface”, we include textiles, clothing, carpets, curtains, upholstery, textile and fabric covered articles, and the like.

The first component may be a gel or liquid. The second component may be a gel or liquid. According to certain preferred embodiments at least one component, more preferably both components are gelled or thickened. According to other preferred embodiment both components are non-gelled or non-thickened liquids. Even more preferably, both components are non-gelled or non-thickened liquids which thicken or gel after the two components are mixed.

When the first and/or second component is a liquid it may be a thin (non-viscous) or watery liquid, or may be a viscous liquid, including a cream or paste. Preferably both the first and second components, when liquid, have a viscosity measured at 25° C. and 21 sec⁻¹ 10,000 mPa.s or less, more preferably 1,000 or less, more preferably 500 or less. The liquid could comprise solids suspended or dissolved therein, or may comprise emulsion droplets suspended therein.

Suitably, as noted hereinbefore, the first and second components are such that when they mix, i.e. are combined, the temperature of the resultant composition is elevated compared to the temperature of the components immediately prior to mixing.

Suitably, in use, appropriate relative amounts of the components are mixed such that the ingredients of said components mix in the amounts required to provide the desired temperature rise and, optionally, any other desired properties. In preferred embodiments, the components are preferably mixed in a ratio between 10:1 and 1:10 by weight, more preferably between 5:1 and 1:5 by weight, most preferably between 2:1 and 1:2 by weight, for example, approximately equal amounts.

In a specific and preferred embodiment of the invention, one component comprises an oxidising agent (oxidant), whilst a second component comprises a reducing agent (reductant). It is highly preferred if the catalyst is present in the second component with the reducing agent, to avoid the risk of decomposition of the oxidising agent on storage. In this embodiment, mixing of the first component and the second component in the presence of the catalyst will result in the rapid initiation of a redox reaction, with consequent heat generation. As noted previously, the production of heat in this manner is particularly advantageous in cleaning products or compositions as heat will generally tend to speed up the cleaning process, thus providing a faster acting, easier to use, and more useful cleaning product than those without the redox technology described herein. Moreover, the environment of the cleaning composition will be improved for the user.

In a yet further advantage, cleaning products as defined herein comprising one component comprising an oxidising agent, and a second component comprising a reducing agent, form when combined, a cleaning composition which is found to self-emulsify, at least to some extent, common staining elements, for example grease/fatty stains, and the like. As such, the cleaning products are “self-cleaning”, i.e. no user input is required over and above the mixing of the components to form the cleaning composition on the surface, to at least begin the cleaning process.

Generally, the more heat produced by the redox reaction, the greater the increase in temperature of the cleaning composition system when the components are mixed, and hence the greater the potential increase in the speed and efficiency of the cleaning process using the system, particularly when combined with the self-emulsification of grease effect noted hereinbefore. The presence of the catalyst means that the optimal temperature is attained rapidly after mixing so that the cleaning may be affected immediately by the user. Nevertheless, whilst the generation of heat in situ is a very attractive proposition for cleaning products for use on both hard and on fabric surfaces, and in products such as depilatories, there is clearly an upper temperature limit, above which the user of the system would be placed at an unacceptable risk of injury/burns. Therefore, and preferably, the temperature of the cleaning compositions of this embodiment in use will be above ambient temperature, i.e. above the temperature of the two components before direct mixing, but below a temperature likely to cause injury/burns to the user of the composition, preferably at a temperature above ambient temperature, preferably in the range 25^{O}C to 75^{O}C, more preferably 30^{O}C to 65^{O}C, more preferably in the range 35^{O}C to 60^{O}C, most preferably in the range 40^{O}C to 55^{O}C, for example at about 45^{O}C, or about 55^{O}C. However, the cleaning compositions may attain higher temperatures than those set out above for a time before the user comes into direct contact with the composition, i.e. whilst self-emulsification of the grease or other stain may be occurring. The presence of the catalyst gives the advantage that the heat generation takes place rapidly, enabling better control of the maximum temperature attained.

Suitable oxidising agents include both peroxygen-based oxidising agents and hypohalite-based oxidising agents. Examples include hydrogen peroxide, hypochlorous acid, hypochlorites, hypocodites, and percarbonates. Also included are alkali metal chlorites, hypochlorites and perborates, for example sodium chlorite, sodium hypochlorite and sodium perborate. However, particularly preferred as the oxidising agent are peroxides, most particularly hydrogen peroxide. Thus, in a particularly preferred embodiment of the invention, either the first or the second component comprises hydrogen peroxide.

Preferably, the oxidising agent may also be an active oxygen generator, and this constitutes a yet still further advantage of the present invention, wherein the presence of active oxygen precursors or active oxygen producers/releasers is an advantage, e.g. in bleaching situations, particularly on fabrics.

Peroxygen bleaching agents are preferred. Suitable peroxygen bleaching compounds include sodium carbonate peroxyhydrate and equivalent “percarbonate” bleaches, sodium pyrophosphate peroxyhydrate, urea peroxyhydrate, and sodium peroxide. Persulfate bleach (e.g., OXONE, manufactured commercially by DuPont) can also be used.

Peroxygen bleaching agents, the perborates, the percarbonates, etc., are preferably combined with bleach activators, which lead to the in situ production in aqueous solution of the peroxy acid corresponding to the bleach activator. Various nonlimiting examples of activators are disclosed in U.S. Pat. No. 4,915,854, issued Apr. 10, 1990 to Mao et al, and U.S. Pat. No. 4,412,934. The nonanoyloxybenzene sulfonate (NOBS) and tetraacetyl ethylene diamine (TAED) activators are typical and are preferred, and mixtures thereof can also be used. See also U.S. Pat. No. 4,634,551 for other typical bleaches and activators useful herein.

Hydrogen peroxide is a chemical that has particular user compliance considerations. It is a relatively strong oxidising agent and as such, concentrated hydrogen peroxide solutions should not be in direct contact with the user. Although in the present invention, the oxidising agent combines with the reducing agent in the presence of a catalyst to form the cleaning composition, the presence of relatively high concentration oxidising agents even as part of one of the components could prove dangerous. For instance, if the oxidising and reducing agents are not completely mixed or combined, there exists the possibility of non-reduced oxidising agent being touched by the user. Moreover, should the mixing or combining mechanism of the two components malfunction in any way, it is again possible for non-reduced oxidising agent to be present. Hence, it is preferable for the concentration of oxidising agent to be as low as possible, whilst still retaining the ability to react with the reducing agent and thus provide a heated composition. The presence of the catalyst means that less oxidising agent is needed for the heat generation, as less heat is lost to the environment as the maximum temperature is attained more rapidly.

Preferably, therefore, the oxidising agent is present in the component comprising the oxidising agent at a concentration of less than 20 wt % (where weight percent of oxidising agent is the concentration of oxidising agent in its solution in the component, i.e. the weight percent of the oxidising agent in the component comprising the oxidising agent), more preferably at a concentration of less than 1 0 wt %, yet more preferably in the range of 2 to 9 wt %, still yet more preferably in the range of 3 to 8 wt %, most preferably in the range of 4 to 8 wt %, for example at about 6-7 wt %.

It is found that if there is too much oxidising agent present, then too much heat is produced, leading to safety issues/concerns, and/or the risk posed by the presence of non-reduced oxidising agent (for example, in the case of malfunction) is too high. Moreover, the lower limit is set by the need to produce an appreciable temperature rise, and preferably, to have a slight excess of oxidising agent to provide some active oxygen, particularly for use on fabric substrates.

Another aspect of the invention is a method of treating soft surfaces, particularly fabrics with a product comprising separate first and second compartments, the first compartment containing a first component of a composition in a stable environment, the second compartment containing a second component of the composition in a stable environment, wherein, in use, the said two components are combined together to form said composition, and wherein the temperature of said composition is elevated when compared to the temperature of the components prior to said combination. For this aspect of the invention, it is not essential that wherein one of the components comprises a catalyst for a reaction between the first and second components. This is because the two mixed components may be left for some time on the soft surface to be treated. However the presence of a catalyst is preferred.

Suitable reducing agents include sulfides, sulfites, sulfates, oxazolidines, ascorbic acid, oxalic acid, iodides, ferrous ammonium sulphate, and thiosulfates, preferably alkali metal thiosulfates. Examples include sodium thiosulfate, sodium sulfite, potassium iodide. More preferred are thiosulfates, and most preferred is sodium thiosulfate. The reducing agent should be chosen to ensure that the oxidising agent behaves thus.

The preferred amount of reducing agent in the component comprising the reducing agent is preferably such that there is sufficient reducing agent present to reduce all, substantially all, or at least most, of the oxidising agent present in the other component, whilst providing a suitable temperature rise, as discussed hereinbefore. More preferably, the concentration of reducing agent is the same, or substantially the same, as the amount of oxidising agent present in the other component. Even more preferably, the reducing agent is present in the component comprising the reducing agent at a concentration of less than 20 wt % (where weight percent of reducing agent is the concentration of reducing agent in its solution in the component, i.e. the weight percent of the reducing agent in the component comprising the reducing agent), yet more preferably at a concentration of less than 10 wt %, more preferably in the range of 2 to 9 wt %, even more preferably in the range of 3 to 9 wt %, yet even more preferably in the range of 3 to 8 wt %, most preferably in the range of 4 to 7 wt %, for example in the range 5 to 7 wt %, e.g. about 6 wt %.

It is found that if there is too much reducing agent present, then too much heat is produced, leading to safety issues/concerns. Moreover, at too elevated levels of reducing agent there may be issues of the amount of residue left on the surface. Moreover, if there is too little reducing agent present, not enough heat will be generated in the composition, and some oxidising agent may be left unreacted, leading potentially to problems concerning safety, as noted hereinbefore, and in addition excess oxidising agent, for example hydrogen peroxide, can lead to the formation of a yellow discolouration (if any base is present) and a disagreeable odour. The presence of catalyst ensures that the reaction between the components rapidly goes to completion, helping to avoid such problems.

Thus, in a preferred embodiment of the present aspect of the invention there is provided a cleaning product comprising separate first and second compartments, the first compartment containing a first component comprising an oxidising agent in a stable environment, the second compartment containing a second component comprising a reducing agent in a stable environment and a catalyst, wherein, in use, the said two agents are combined together to form a composition, preferably a cleaning composition, and wherein the temperature of said composition is elevated when compared to the temperature of the components prior to said combination. Alternatively, the first component may contain a first component comprising a reducing agent in a stable environment and a catalyst, the second compartment containing a second component comprising an oxidising agent in a stable environment.

The component comprising a reducing agent further comprises a catalyst capable of catalysing the redox reaction between the said reducing agent and the oxidising agent in the other compartment of the product. The presence of the catalyst generally has the effect of speeding-up the redox reaction between the oxidising agent and reducing agent, thus ensuring the elevated temperature of the composition is reached earlier than in cases where no such catalyst is present.

Thus, the component comprising the reducing agent further comprises a catalyst that increases the rate of the redox reaction between the particular oxidising and reducing agents. Preferably, the catalyst comprises a metal-containing ion, more preferably a transition metal-containing ion, for example containing an ion of manganese, copper, molybdenum, or tungsten, together with an alkali or alkaline earth metal, such as sodium. More preferably, the catalyst is a tungstate compound, although other ions comprising a transition metal ion and oxygen, e.g. manganese, copper, or molybdenum with oxygen, can be used. Yet more preferably, the catalyst is an alkali metal tungstate (e.g. contains the WO₄²⁻ ion), most preferably sodium tungstate (e.g. Na₂WO₄), suitably in the form sodium tungstate dihydrate (e.g. Na₂WO₄.2H₂O).

The catalyst is present in an amount sufficient to catalyse the reaction between the particular oxidising and reducing agents chosen. More preferably, the catalyst is present to a maximum of 2 wt % of the weight of the component comprising the reducing agent, even more preferably to a maximum of 1 wt %, yet more preferably in the range 0.01 to 0.8 wt %, even more preferably in the range 0.1 to 0.5 wt %, for example at about 0.2 wt % or at about 0.5 wt %.

It is found that if there is too little catalyst present, the redox reaction will proceed in a similar manner to if no catalyst was present (i.e. there is essentially a “critical” weight of catalyst that must be present for catalysis of the redox reaction to take place).

Preferably, still further ingredients can be present in either or both of the components which form the composition, as detailed in this aspect of the present invention. In view of the fact that the components are kept in separate compartments as and until the cleaning product is used, the present invention further provides a way in which mutually incompatible or antagonistic ingredients can be kept separate throughout the shelf-life of the product, as and until the product is used. This forms a still yet further advantage of the present invention.

Conventionally, cleaning compositions are generally ready-made compositions which include all of the cleaning ingredients, and which are then stored in a convenient container until needed. Thus, ingredients which are antagonistic towards each other or are mutually incompatible are generally avoided, thus placing restraints on the ingredients that can be used in the compositions.

Examples of antagonistic ingredients include ingredients which would react with each other, or ingredients which would inhibit another ingredient's activity, when in the same composition. Where ingredients are mildly antagonistic they may be tolerated together in some compositions but with the shelf-life of such compositions being compromised.

As noted above, cleaning compositions are generally formulated so as to avoid antagonistic ingredients, even if only mildly antagonistic. This puts constraints on the design of such pre-formulated compositions. There is a trade-off between stability and cleaning efficacy and/or cleaning spectrum (by which we mean the range of cleaning tasks which can be tackled). Stability is paramount in product design since consumers will not generally accept a product with short shelf-life. Consequently, cleaning efficacy may be modest and/or the cleaning spectrum narrow.

The present invention thus provides the further advantage that mutually incompatible or antagonistic ingredients, even mildly antagonistic ingredients, can be found in the same cleaning product, without their presence having any negative effect on the shelf-life of the product. In essence, the mutually incompatible or antagonistic ingredients will be placed in separate compartments in the product, for example, in the first and second components respectively.

Preferably, the product of the invention further comprises at least one surfactant and/or emulsification aid.

Suitable surfactants and/or emulsification aids include anionic, cationic, non-ionic and amphoteric or zwitterionic surfactants.

One class of nonionic surfactants which may be used in the present invention are alkoxylated alcohols, particularly alkoxylated fatty alcohols. These include ethoxylated and propoxylated fatty alcohols, as well as ethoxylated and propoxylated alkyl phenols, both having alkyl groups of from 7 to 16, more preferably 8 to 13 carbon chains in length.

Examples of alkoxylated alcohols include certain ethoxylated alcohol compositions presently commercially available from the Shell Oil Company (Houston, Tex.) under the general trade name NEODOL (trade mark), which are described to be linear alcohol ethoxylates and certain compositions presently commercially available from the Union Carbide Company, (Danbury, Conn.) under the general trade name TERGITOL (trade mark) which are described to be secondary alcohol ethoxylates.

Examples of alkoxylated alkyl phenols include certain compositions presently commercially available from the Rhône-Poulenc Company (Cranbury, N.J.) under the general trade name IGEPAL (trade mark), which are described as octyl and nonyl phenols.

Examples of anionic surface active agents which may be used in the present invention include but are not limited to: alkali metal salts, ammonium salts, amine salts, aminoalcohol salts or the magnesium salts of one or more of the following compounds: alkyl sulphates, alkyl ether sulphates, alkylamidoether sulphates, alkylaryl polyether sulphates, monoglyceride sulphates, alkylsulphonates, alkylamide sulphonates, alkylarylsulphonates, olefinsulphonates, paraffin sulphonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl saronsinates, acyl isothionates and N-acyl taurates. Generally, the alkyl or acyl group in these various compounds comprises a carbon chain containing 12 to 20 carbon atoms.

Other anionic surface active agents which may be used include fatty acid salts, including salts of oleic, ricinoleic, palmitic and stearic acids; copra oils or hydrogenated copra oil acid, and acyl lactylates whose acyl group contains 8 to 20 carbon atoms.

Examples of cationic surfactants which may be used in the present invention include quaternary ammonium compounds and salts thereof, including quaternary ammonium compounds which also have germicidal activity and which may be characterized by the general structural formula: 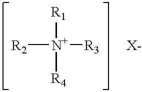
when at least one of R₁, R₂, R₃ and R₄ is a hydrophobic, aliphatic, aryl aliphatic or aliphatic aryl group containing from 6 to 26 carbon atoms, and the entire cationic portion of the molecule has a molecular weight of at least 165. The hydrophobic groups may be long-chain alkyl, long-chain alkoxy aryl, long-chain alkyl aryl, halogen-substituted long-chain alkyl aryl, long-chain alkyl phenoxy alkyl or aryl alkyl. The remaining groups on the nitrogen atoms, other than the hydrophobic radicals, are generally hydrocarbon groups usually containing a total of no more than 12 carbon atoms. R₁, R₂, R₃ and R₄ may be straight chain or may be branched, but are preferably straight chain, and may include one or more amide or ester linkages. X may be any salt-forming anionic moiety.

Examples of quaternary ammonium salts within the above description include the alkyl ammonium halides such as cetyl trimethyl ammonium bromide, alkyl aryl ammonium halides such as octadecyl dimethyl benzyl ammonium bromide, and N-alkyl pyridinium halides such as N-cetyl pyridinium bromide. Other suitable types of quaternary ammonium salts include those in which the molecule contains either amide or ester linkages, such as octyl phenoxy ethoxy ethyl dimethyl benzyl ammonium chloride and N-(laurylcocoaminoformylmethyl)-pyridinium chloride. Other effective types of quaternary ammonium compounds which are useful as germicides includes those in which the hydrophobic moiety is characterized by a substituted aromatic nucleus as in the case of lauryloxyphenyltrimethyl ammonium chloride, cetylaminophenyltrimethyl ammonium methosulphate, dodecylphenyltrimethyl ammonium methosulphate, dodecylphenyltrimethyl ammonium chloride and chlorinated dodecylphenyltrimethyl ammonium chloride.

Preferred quaternary ammonium compounds which act as germicides and which are useful in the present invention include those which have the structural formula: 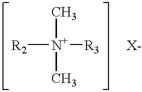
wherein R₂ and R₃ are the same or different C₈-C₁₂alkyl, or R₂ is C₁₂-C₁₆alkyl, C₈-C₁₈alkylethoxy, C₈-C₁₈alkyl-phenolethoxy and R₃ is benzyl, and X is a halide, for example chloride, bromide or iodide, or methosulphate. Alkyl groups R₂ and R₃ may be straight chain or branched, but are preferably substantially linear.

A mixture of two or more surface active agents may also be used. Other known surface active agents not particularly described above may also be used. Such surface active agents are described in McCutcheon's Detergents and Emulsifiers, North American Edition, 1982; Kirk-Othmer, Encyclopaedia of Chemical Technology, 3rd Ed., Vol. 22, pp 346-387.

More preferably, the at least one surfactant and/or emulsification aid is present in the component comprising a reducing agent, preferably a reducing agent and a catalyst, even more preferably at a level of at least 0.5 wt % of the component, more preferably at least 0.6 wt % of the component, yet more preferably from 0.5 to 2.5 wt %, even more preferably from 0.6 to 2.1 wt %, more preferably at least 0.75 wt %, for example 0.9 to 1.2 wt %. Should the surfactant actually be added to the component as a pre-formulated surfactant/water mix, the ranges noted above would be adjusted accordingly. For example, for a surfactant solution supplied as a 30% by weight surfactant in water solution, the amount of surfactant solution present should preferably be present at a level of at least 2 wt % of the component, yet more preferably from 2 to 7 wt %, more preferably at least 2.5 wt %, for example 3 to 4 wt %.

A yet further ingredient preferably in the component comprising a reducing agent and a catalyst, is a base. The presence of the base will assist in maintaining the desired alkaline pH levels of the compositions of the invention and thus avoid the unpleasant odours associated with the compositions if the pH falls below neutral, i.e. below pH=7. Although most bases are suitable, particularly preferred examples include amino-alcohol compounds, such as 2-aminoethanol, especially for hard surface cleaners, and carbonates, such as sodium carbonate, especially for fabric or soft surface cleaners. When used in a method for treating soft surfaces, particularly fabrics as a stain remover or pre-treatment method prior to washing, it is not essential that the component comprising a reducing agent also comprises a catalyst, though this is preferred.

Preferably, when present, the basic compound represents 3 to 10 wt % of the component comprising a reducing agent, preferably a reducing agent and a catalyst, more preferably 4.5 to 9 wt %, yet more preferably 5 to 7 wt %. Most preferably, when the base is a carbonate, the base represents 6 to 9 wt % of the component comprising a reducing agent, for example about 7 wt %. Furthermore, when the base is an amino-alcohol compound, the base represents 3 to 7 wt % of the component comprising a reducing agent, for example about 3 to 4 wt %. In essence, the level of base required is governed by the desire for an excess of base in order to maintain an alkaline pH with the particular reducing agent.

It is found that if the level of base is too low, an unacceptably high excess of hydrogen peroxide may be present when the cleaning product is used, potentially leading to problems as hereinbefore described. However, if the level of base is too high, the composition formed can be an irritant and/or have a corrosive nature, and furthermore there may be negative odour and discolouration effects, and/or residues left on the surface.

Further ingredients which may be present in at least one component of the product of the invention are one or more organic solvents. These one or more organic solvents may be present in any effective amounts which may be observed to be advantageous in facilitating in improving the cleaning characteristics of the product of the invention. By way of non-limiting example exemplary useful organic solvents which may be included at least one component of the product of the invention include those which are at least partially water-miscible such as alcohols (e.g., low molecular weight alcohols, such as, for example, ethanol, propanol, isopropanol, and the like), glycols (such as, for example, ethylene glycol, propylene glycol, hexylene glycol, and the like), water-miscible ethers (e.g. diethylene glycol diethylether, diethylene glycol dimethylether, propylene glycol dimethylether), water-miscible glycol ether (e.g. propylene glycol monomethylether, propylene glycol mono ethylether, propylene glycol monopropylether, propylene glycol monobutylether, ethylene glycol monobutylether, dipropylene glycol monomethylether, diethyleneglycol monobutylether), lower esters of monoalkylethers of ethylene glycol or propylene glycol (e.g. propylene glycol monomethyl ether acetate), and mixtures thereof. Glycol ethers having the general structure Rₐ—R_{b}—OH, wherein Rₐ is an alkoxy of 1 to 20 carbon atoms, or aryloxy of at least 6 carbon atoms, and R_{b} is an ether condensate of propylene glycol and/or ethylene glycol having from one to ten glycol monomer units. Of course, mixtures of two or more organic solvents may be used in the organic solvent constituent. These one or more organic solvent may be included in either the first component, or the second component or in both components and may be included in any effective amount. Desirably the one or more organic solvents present in either or both components do not exceed 10% wt. of the component composition of which they form a part, but more preferably are present in amounts of 0.01 to 7% wt., more preferably are present in amount of 0.05 to 5% wt. of a component of which they form a part.

As noted previously one or both of the components of the product of the invention may be thickened or gelled. One or both of the components of the product of the invention may include thickening or gelling agents. Exemplary thickeners useful in the present invention include polysaccharide polymers including those selected from cellulose, alkyl celluloses, alkoxy celluloses, hydroxy alkyl celluloses, alkyl hydroxy alkyl celluloses, carboxy alkyl celluloses, carboxy alkyl hydroxy alkyl celluloses, naturally occurring polysaccharide polymers such as xanthan gum, guar gun, locust bean gum, tragacanth gum, or derivatives thereof, polycarboxylate polymers, polyacrylamides, clays, and mixtures thereof.

Examples of the cellulose derivatives include methyl cellulose ethyl cellulose, hydroxymethyl cellulose hydroxy ethyl cellulose, hydroxy propyl cellulose, carboxy methyl cellulose, carboxy methyl hydroxyethyl cellulose, hydroxypropyl cellulose, hydroxy propyl methyl cellulose, ethylhydroxymethyl cellulose and ethyl hydroxy ethyl cellulose.

Exemplary polycarboxylate polymers thickeners have a molecular weight from about 500,000 to about 8,000,000, preferably from about 1,000,000 to about 4,000,000, with, preferably, from about 0.5% to about 10% crosslinking. Preferred polycarboxylate polymers include polyacrylate polymers including those sold under trade names Carbopol®, Acrysol® ICS-1 and Sokalan®. The preferred polymers are polyacrylates. Other monomers besides acrylic acid can be used to form these polymers including such monomers as ethylene and propylene which act as diluents, and maleic anhydride which acts as a source of additional carboxylic groups.

The polycarboxylate polymer can be a non-associative thickener or stabilizer, such as a homopolymer or a copolymer of an olefinically unsaturated carboxylic acid or anhydride monomers containing at least one activated carbon to carbon olefinic double bond and at least one carboxyl group or an alkali soluble acrylic emulsion, or an associative thickener or stabilizer, such as a hydrophobically modified alkali soluble acrylic emulsion or a hydrophobically modified nonionic polyol polymer, i.e., a hydrophobically modified urethane polymer, or combinations thereof. The copolymers are preferably of a polycarboxylic acid monomer and a hydrophobic monomer. The preferred carboxylic acid is acrylic acid. The homopolymers and copolymers preferably are crosslinked.

Other polycarboxylic acid polymer compositions which can be employed include, for example, crosslinked copolymers of acrylates, (meth)acrylic acid, maleic anhydride, and various combinations thereof. Commercial polymers are available from Rheox Inc., Highstown, N.J. (such as Rheolate® 5000 polymer), 3 V Sigma, Bergamo, Italy (such as Stabelyn® 30 polymer, which is an acrylic acid/vinyl ester copolymer, or Polygel® and Synthalen® polymers, which are crosslinked acrylic acid polymers and copolymers), Noveon (such as Carbopol 674 (lightly crosslinked polyacrylate polymer), Carbopol 676 (highly crosslinked polyacrylate polymer), Carbopol EP-1 thickener, which is a acrylic emulsion thickener), or Rohm and Haas (such as Acrysol® ICS-1 and Aculyn® 22 thickeners, which are hydrophobically modified alkali-soluble acrylic polymer emulsions and Aculyn® 44 thickener, which is a hydrophobically modified nonionic polyol). Preferred are the Carbopol® and Pemulen® polymers, generally. The choice of the specific polymer to be employed will depend upon the desired rheology of the composition, and the identity of other compositional ingredients.

Exemplary clay thickeners comprise, for example, colloid-forming clays, for example, such as smectite and/or attapulgite types. The clay materials can be described as expandable layered clays, i.e., aluminosilicates and magnesium silicates. The term “expandable” as used to describe the instant clays relates to the ability of the layered clay structure to be swollen, or expanded, on contact with water. The expandable clays used herein are those materials classified geologically as smectites (or montmorillonite) and attapulgites (or polygorskites).

Further useful and commercially available clays include, for example, montmorillonite, bentonite, volchonskoite, nontronite, beidellite, hectorite, saponite, sauconite, vermiculite and attapulgite (polygorskite). The clays herein are available under various trade names such as Gelwhite GP, Gelwhite H, Mineral Colloid BP, and Laponite from Southern Clay Products, Inc., Texas; Van Gel O from R. T. Vanderbilt and Attagel, i.e. Attagel 40, Attagel 50 and Attagel 150 from Engelhard Minerals & Chemicals Corporation.

When present in either or both of the components of the product of the invention, the amount of thickener or gelling agent can range from about 0.01 to 10% wt., preferably is present from 0.025% to 5% wt.

Yet still further ingredients that can be present in at least one component of the product of the invention include bleaching agents, fragrances, malodour reducers or neutralisers, biocides, enzymes, insecticides, anti-static agents, antimicrobial agents, allergen neutralisers, anti-fungal agents, sequestrants, buffers and other pH adjusting agents. Other further ingredients could be envisaged and appreciated by those skilled in the art.

Exemplary pH adjusting agents or pH buffer compositions include many which are known to the art and which are conventionally used. By way of non-limiting example pH adjusting agents include phosphorus containing compounds, monovalent and polyvalent salts such as of silicates, carbonates, and borates, certain acids and bases, tartrates and certain acetates. Further exemplary pH adjusting agents include mineral acids, basic compositions, and organic acids, which are typically required in only minor amounts. By way of further non-limiting example pH buffering compositions include the alkali metal phosphates, polyphosphates, pyrophosphates, triphosphates, tetraphosphates, silicates, metasilicates, polysilicates, carbonates, hydroxides, and mixtures of the same. Certain salts, such as the alkaline earth phosphates, carbonates, hydroxides, can also function as buffers. It may also be suitable to use as buffers such materials as aluminosilicates (zeolites), borates, aluminates and certain organic materials such as gluconates, succinates, maleates, and their alkali metal salts. Either or both the first component and the second component may include an effective amount of an organic acid and/or an inorganic salt form thereof which may be used to adjust and maintain the pH of the compositions of the invention to the desired pH range. Particularly useful is citric acid and metal salts thereof such as sodium citrate which are widely available and which are effective in providing these pH adjustment and buffering effects. When present the pH adjusting agents or pH buffer compositions are present in amount which are effective in attaining or maintaining a desired or target pH of a composition. Generally the pH adjusting agents or pH buffer compositions are present in the first component, the second component or in both components in amount not in excess of 5% wt. of the component of which they form a part.

Nevertheless, in the preferred embodiment of cleaning products, preferably at least one of a surfactant, bleaching agent, or enzyme is present in at least one of the components, preferably in the component comprising a reducing agent, preferably comprising a reducing agent and a catalyst. Together with the temperature rise and the ingredients of the components described hereinbefore, the at least one of a surfactant, bleaching agent, or enzyme will further improve the cleaning properties of the product of this aspect of the present invention.

Biocides

An antimicrobial active ingredient can function as a biocide. Typical biocides for use in the composition of the present invention include trichlosan and quaternary ammonium compounds,—such as the quaternary surfactant-based agent para-chloro meta xylenol (PCMX).

Enzymes

Enzymes can be included in the composition of the present invention for a wide variety of laundering purposes, including removal of protein-based, carbohydrate-based, or triglyceride-based stains, for example, and for the prevention of dye transfer, and for fabric restoration. The enzymes to be incorporated include proteases, amylases, lipases, cellulases, and peroxidases, as well as mixtures thereof. Other types of enzymes may also be included. They may be of any suitable origin, such as vegetable, animal, bacterial, fugal and yeast origin. However, their choice is governed by several factors such as pH-activity and/or stability optima, thermostability, stability versus active detergents, builders and so on. In this respect bacterial or fungal enzymes are preferred, such as bacterial amylases and proteases, and fungal cellulases.

Other possible ingredients in the components of the composition of the invention include insecticides, anti-allergenic agents, anti-static agents, antimicrobial agents, allergen neutralisers, and anti-fungal agents. Accordingly, the potential uses of the composition of the invention will in essence be determined by the nature and specific characteristics of the ingredient or ingredients selected.

Suitably, the components of the product of the invention comprise water in order to make each component up to 100%. Preferably, the water is de-ionised water.

As the product of the present aspect of the invention features two components in separate compartments, a yet further advantage of the present invention, as noted hereinbefore, is that antagonistic, even slightly antagonistic ingredients, or even mutually exclusive ingredients, can be kept within the same product. Assuming these said ingredients are kept within initially separate components, they will not come into contact as and until the product is in use and the two components are combined together. Antagonistic ingredients, even mildly antagonistic ingredients, could not be used together in practicable pre-formulated products. In the present invention in which the composition is formed substantially in situ, these ingredients can be segregated for as long as is required, i.e. for the shelf-life of the product, in the first and second compartments. Thus, the cleaning product of the invention offers the prospect of valuable efficacy benefits, over pre-formulated products, wherein by “pre-formulated” we mean that all components of the cleaning composition are combined in the cleaning product in a single formulation.

Examples of ingredients that can advantageously be kept apart in the separate first and second compartments respectively, as and until the product is in use, include the following: acidic and alkaline moieties, acidic and halogen-containing moieties, a compound able to release active oxygen and an activator therefor, a peroxide moiety and an alkaline moiety, enzymes and co-enzymes (or enzyme catalyst), an enzyme and a peroxide moiety, an enzyme and a bleach, two enzyme moieties, a peroxide moiety and a hypochlorite compound, two surfactants not being apt for long-term storage in admixture (e.g. an anionic and a cationic surfactant), two fragrances (which may be of a type incompatible for a pre-formulation together or which, when mixed, cause a detectable fragrance change), moieties which when mixed cause a viscosity change or foaming/de-foaming effect, moieties which when mixed lead to the generation of light. It will of course be appreciated that the embodiments described above are not mutually exclusive.

In any or all of the specific embodiments noted above, it is preferable that the first and second components further comprise compositions conventionally used in cleaning compositions and the like. Hence, the antagonistic ingredients brought together by the application of the stimulus can also themselves function as cleaning agents, or alternatively, may simply indicate to the user that mixing of the phases has taken place and thus that the cleaning composition has now been formed.

The first and second components hereinbefore described can further comprise other ingredients which may have a beneficial effect on the compositions in cleaning methods. For instance, the first and/or second components may further comprise at least one or more surfactants (e.g. of the types described above).

The cleaning composition may be antimicrobial. Preferably, the antimicrobial effect is generated when the first and second components mix. Preferably, an antimicrobial chemical is generated in situ or released when the components of the composition mix. The antimicrobial chemical may, for example, comprise an iodate, bromate, thiocyanate, chlorate or peroxy compound, or chlorine dioxide (for example generated from a chlorite), hypochlorous acid (for example generated from hypochlorite), chlorine, bromine or iodine.

As noted hereinbefore, the pH of the composition formed when the components are combined is in the range suitable for direct handling by the user of the composition. Preferably, the pH of the composition is approximately neutral or slightly alkaline, more preferably in the range greater than 7 to 11, even more preferably in the range 7.5 to 10.5, most preferably in the range 7.5 to 10, e.g. in the range 8 to 9.5. In such pH ranges, the composition is both an effective cleaning composition and is tolerable to the user's skin, even over extended contact periods. Moreover, preferably, the pH value of the composition formed by combining the two components is essentially stable after the combination, at least stable within the pH ranges mentioned hereinabove, more preferably within the preferred ranges mentioned hereinabove. Thus, the products of the present invention are preferably effective in situations where an alkaline composition is effective, for example in situations where the self-emulsification of grease, and the like, is an advantage.

As such, it has surprisingly been found that in addition to the advantages noted hereinbefore, cleaning compositions formed by combining the components of the products of the invention, exhibit certain “self-cleaning” properties. For example, the compositions begin to emulsify and therefore remove common stains, such as grease and greasy stains, and the like. Providing compositions within the pH ranges noted hereinbefore provides unexpected and surprising advantages in that the compositions self-emulsify grease/proteinaceous stains, and the like.

According to a second aspect of the invention there is provided a method of manufacturing a cleaning product, the method comprising:
a) providing a first compartment and a separate second compartment;
b) providing a first component of a cleaning composition in a stable environment in the first compartment and a second component of the cleaning composition in a stable environment in the second compartment;
c) sealing the compartments; and
d) arranging said compartments such that each component can be combined together to form said composition, either directly on the surface to be cleaned, or immediately before addition of the pre-mixed composition to the surface and wherein the temperature of said composition is elevated when compared to the temperature of the components prior to said combination.

Preferably, the first compartment, second compartment, first and second components, are as described hereinabove for the first aspect of the invention.

According to a third aspect of the invention there is provided a method of providing a cleaning composition, the method comprising providing a cleaning product of the first aspect of the invention and effecting the combination of the first and second components to form the said cleaning composition, and wherein the temperature of said composition is elevated when compared to the temperature of the components prior to said combination.

According to a fourth aspect of the invention there is provided a method of treating a surface or part of a surface, preferably cleaning a surface or part of a surface, the method comprising contacting a surface to be treated or cleaned with the cleaning composition produced by the method of the third aspect of the invention, or sequentially, simultaneously, or separately contacting the said surface with the components of said composition, wherein the temperature of said composition is elevated when compared to the temperature of the components prior to said combination.

According to a fifth aspect of the invention there is provided the use of a product as defined hereinbefore to form a composition as defined hereinbefore in the treatment of a surface or part of a surface, preferably the cleaning of a surface or part of a surface.

According to a sixth aspect of the invention there is provided a kit comprising separate first and second compartments, the first compartment containing a first component of a composition in a stable environment, the second compartment containing a second component of the composition in a stable environment, wherein, in use, the said two components are combined together to form said composition, and wherein the temperature of said composition is elevated when compared to the temperature of the components prior to said combination, and wherein the said components can be applied to a substrate or surface or released from said kit, simultaneously, sequentially or separately.

According to a seventh aspect of the invention there is provided an applicator means comprising separate first and second compartments, the first compartment containing a first component of a composition in a stable environment, the second compartment containing a second component of the composition in a stable environment, wherein said means can apply said components to a substrate or surface simultaneously, sequentially or separately to form said composition and wherein the temperature of said composition is elevated when compared to the temperature of the components prior to said combination.

Another aspect of the invention is a method for cleaning a surface comprising the steps: i) effecting the combination of the first and second components of the product of the invention on the surface to be cleaned to form the composition of the invention (preferably a cleaning composition) wherein the temperature of the composition is elevated when compared to the temperature of the components prior to the combination, ii) cleaning of the surface with the composition by wiping, rubbing or allowing the composition to remain in contact with the surface for a length of time, and iii) substantially removing the composition from the surface.

For the avoidance of any doubt, each and every feature disclosed herein in relation to any one or more aspects of the present invention, is equally applicable to any or all of the other aspects of the invention, unless any such features are mutually exclusive or incompatible.

By “compartments”, we simply mean a region or container where the particular component is kept until use.

The application of the components to the surface can be carried out by any convenient means, for example, by roll-on, spraying (e.g. from an aerosol or pump dispenser), brushing, painting, pouring, rubbing, squeezing etc. Examples of suitable applicator means include any multi-compartment device wherein the components are kept separate from each other as and until application by the user is desired. As such, the separator means can be any substantially non-porous structure. Applicator means should preferably be user-friendly and easily-portable, such as multi-compartment blister packs (with each component in a separate blister), or multi-headed, multi-nozzle or nibbed applicators (wherein each component is within a separate compartment within the body of the applicator).

When the applicator means is to apply two components, the applicator comprises two separate compartments. However, when the applicator means is to apply more than two components, either an equivalent number of separate compartments can be provided or, alternatively, an equivalent number of separate compartments can be provided equal to the number of different components.

The compartments of the applicator may contain pre-measured amounts of component to ensure application of the preferred amounts of components. Moreover, compartments may be numbered, or otherwise labelled, to ensure the correct order of sequential application of components.

Alternatively, the components can be mixed within the applicator means before being applied to the surface; preferably, the mixed component should be added to the surface whilst the beneficial elevated temperature properties of the product are still evident.

As noted hereinbefore, it is found that cleaning products comprising cleaning compositions as described hereinbefore, not only may produce an increase in temperature within the composition compared to the temperature of the components, but may produce a cleaning composition that will lead to the self-emulsification of common staining elements, for example grease/fatty stains/proteinaceous stains, and the like. Thus, the compositions of the invention may possess a self-cleaning effect, leading to the cleaning process being begun as soon as the composition is added to the surface to be cleaned, even without any further intervention from the user.

It will be appreciated that the present invention offers many benefits and advantages to the user. In particular, the cleaning products of the invention enable cleaning compositions to comprise ingredients that under normal conditions would react and/or combine with each other before such reaction and/or combination was required. The ingredients are effectively separated in the compartments of the cleaning products disclosed herein as and until it is desired to use the product, from which point the ingredients will combine and/or react, thus providing the particular desired effect of the embodiment. Moreover, the cleaning compositions are provided at an elevated temperature and begin the cleaning and/or emulsification process on the surface even before the user performs any further function over and above adding the composition to the surface. Furthermore, the cleaning compositions are provided at a stable and advantageous pH level. Furthermore, if a cleaning substrate is used, it need not be pre-heated or warmed, nor need the components of the composition be combined on the substrate; the temperature rise when the components mix ensures the components can be added directly to the surface to be treated/cleaned for the desired effect. The subsequent use of a substrate is thus a convenient, but optional, way of removing the composition from the surface.

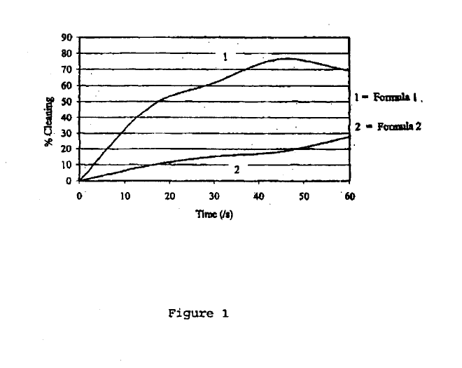

In order that the invention be better understood, embodiments of it will now be described by way of the following illustrative and non-limiting examples and the accompanying figures wherein FIGS. 1-3 show the following:

FIG. 1 shows the % cleaning over time of a product of the present invention and a comparative example,

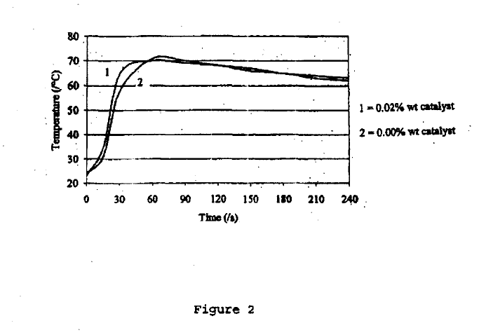

FIG. 2 shows the temperature versus time plot for a catalysed and uncatalysed product of the present invention, and

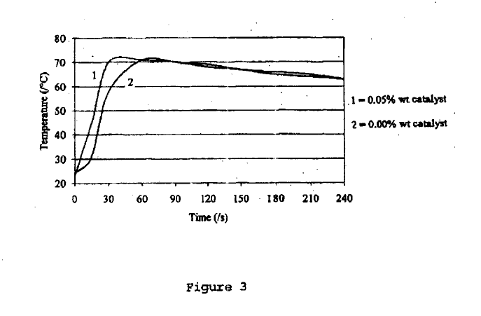

FIG. 3 shows the temperature versus time plot for a further catalysed product and uncatalysed product of the present invention.

### EXAMPLES

The following materials were used in the Examples:

sodium thiosulfate (assay≧98%) supplied by Acros Organics/Fisher Scientific (Leicestershire, UK),

2-aminoethanol (MEA) (assay 99%) supplied by Acros Organics/Fisher Scientific (Leicestershire, UK),

sodium tungstate dihydrate (assay≧99%) supplied by Acros Organics/Fisher Scientific (Leicestershire, UK),

sodium thiosulfate (assay 99%) supplied by Sigma-Aldrich (Dorset, UK),

2-aminoethanol (MEA) (assay≧99%) supplied by Sigma-Aldrich (Dorset, UK),

sodium tungstate dihydrate (assay 99%) supplied by Sigma-Aldrich (Dorset, UK),

Ammonyx LO-E (30% w/w N,N-dimethyldodecylamine-N-oxide in water) supplied by Stepan UK Ltd (Cheshire, UK),

benzalkonium chloride solutions (50% and 80% n-allyldimetllylbenzyl ammonium chlorides in water) supplied by Stepan UK Ltd (Cheshire, UK),

hydrogen peroxide (assay 50%) supplied by Solvay Interox GmbH & Co. KG (Rheinberg, Germany),

Citrus PS-25-M supplied by Robertet (UK) Ltd (Surrey, UK).

### Example 1

Grease Test

A grease composition was prepared by mixing commercially-available vegetable oil, vegetable shortening, lard and carbon black. These components were mixed at 60-80° C. The mixture was then applied to a hardboard via a cloth. The mixture on the hardboard was then allowed to dry.

A cleaning product of the present invention was made up as follows:

Component A

6% by weight sodium thiosulfate,

5% by weight MEA,

0.02% by weight sodium tungstate dihydrate,

4% by weight N,N-dimethyldodecylamine-N-oxide solution (30% w/w in water as Ammonyx LO-E),

0.1076% by weight benzalkonium chlorides,

0.1% by weight Citrus PS-25-M,

balance water.

Component B

6% by weight hydrogen peroxide,

balance water.

In each case, the various ingredients of the component were mixed (at room temperature/ambient pressure) to provide each component with the required level of ingredients. Sufficient hydrogen peroxide (assay 50%) was added to give 6% by weight of actual hydrogen peroxide in Component B; balance water. Initially, Components A and B were kept separate.

For comparative purposes, a standard kitchen cleaner formula was also tested, comprising:

1% by weight dipropylene glycol n-butyl ether,

0.1076% by weight benzalkonium chlorides,

0.02% by weight n-decanol,

0.75% by weight MEA,

2% by weight N,N-dimethyldodecylamine-N-oxide solution (3 0% w/w in water),

0.2% by weight Citrus PS-25-M,

0.002% by weight tartrazine,

balance water.

A still photograph of each untreated grease board was taken. Then 2 g of the comparative cleaner was added to one untreated grease board, and 2 g of the cleaning product of the invention was added to a further untreated grease board. In the latter case, addition was by the simultaneous addition (from pipettes) of 1 g of Component A and 1 g of Component B. The cleaning products were then left on the grease boards for 30 seconds and then blotted dry with a paper towel. Specifically, no user intervention occurred after application of the products, apart from the said blotting dry. After the blotting dry, a further still photograph was taken of each grease board and the results compared. No appreciable change in the level of grease was found for the comparative cleaner. On the other hand, the cleaning product of the invention was found to have removed most of the grease where the product was applied, even without any user intervention (apart from blotting).

### Example 2

Further Grease Tests by Photospectroscopy

Additional blot grease tests were performed using compositions as detailed in Example 1 on grease patches as also detailed in Example 1.

The grease lifting capability of the compositions was tested by using photospectroscopy (using a Minolta Spectrophotometer CM-3700d). The relevant scale was L*=100 when the sample was white, and L*=0 when it was black.

Triplicate samples were blotted after 15, 30, 45 and 60 seconds for both Formula 1 (the two-component composition of the invention from Example 1) and Formula 2 (the comparative composition from Example 1). An average of the 3 samples was taken at each time interval. Visual spectra and appropriate data was taken using the CRIELL L*a*b* colour mode under D65/10^{O} illuminant. The results are shown in Table 2 below, wherein:

% Cleaning=(L*_{cleaned}−L*_{dirty})/(L*_{blank}-L*_{dirty})×100%. Moreover, FIG. 1 of the accompanying drawings shows the % cleaning as a function of time for both Formula 1 and Formula 2.

It is clear from both Table 2 and FIG. 1 that the composition of the present invention (Formula 1) shows a significant improvement in cleaning ability (% cleaning) over the whole time period studied, even without user intervention (apart from blotting).

TABLE 2
% Cleaning = (L*_{cleaned} − L*_{dirty})/(L*_{blank} − L_{dirty}) × 100%

| | | | L* | | | |
|---|---|---|---|---|---|---|
| Sample | Formula | Time (/s) | Blank | Dirty | Cleaned | % Cleaning |
| 1 | 1 | 15 | 92.6415 | 57.3151 | 75.5881 | 51.7 |
| 2 | 1 | 15 | 92.7528 | 55.1735 | 76.9681 | 58.0 |
| 3 | 1 | 15 | 92.6156 | 56.2349 | 66.3018 | 27.7 |
| Ave. | 1 | 15 | | | | 45.8 |
| 4 | 1 | 30 | 94.4351 | 62.2041 | 82.2760 | 62.3 |
| 5 | 1 | 30 | 92.3498 | 57.8988 | 82.8989 | 72.6 |
| 6 | 1 | 30 | 92.4069 | 57.6972 | 75.1679 | 50.3 |
| Ave. | 1 | 30 | | | | 61.7 |
| 7 | 1 | 45 | 91.8154 | 55.3101 | 83.3213 | 76.7 |
| 8 | 1 | 45 | 91.9425 | 55.2745 | 86.3616 | 84.8 |
| 9 | 1 | 45 | 92.1321 | 48.5174 | 78.2522 | 68.2 |
| Ave. | 1 | 45 | | | | 76.6 |
| 10 | 1 | 60 | 92.4688 | 51.2582 | 82.0660 | 74.8 |
| 11 | 1 | 60 | 91.6972 | 53.6187 | 80.0291 | 69.4 |
| 12 | 1 | 60 | 92.2540 | 56.4127 | 79.2603 | 63.7 |
| Ave. | 1 | 60 | | | | 69.3 |
| 13 | 2 | 15 | 92.3613 | 48.0657 | 53.6857 | 12.7 |
| 14 | 2 | 15 | 92.4851 | 60.0072 | 63.9545 | 12.2 |
| 15 | 2 | 15 | 92.3149 | 54.2797 | 55.4333 | 3.0 |
| Ave. | 2 | 15 | | | | 9.3 |
| 16 | 2 | 30 | 92.2251 | 53.6970 | 61.1354 | 19.3 |
| 17 | 2 | 30 | 92.4440 | 58.4530 | 57.8922 | −1.6 |
| 18 | 2 | 30 | 92.4268 | 39.6930 | 54.4273 | 27.9 |
| Ave. | 2 | 30 | | | | 15.2 |
| 19 | 2 | 45 | 92.4810 | 51.5011 | 56.0604 | 11.1 |
| 20 | 2 | 45 | 92.4353 | 59.2380 | 64.9699 | 17.3 |
| 21 | 2 | 45 | 91.4790 | 56.8390 | 66.0119 | 26.5 |
| Ave. | 2 | 45 | | | | 18.3 |
| 22 | 2 | 60 | 91.7156 | 58.4038 | 69.4559 | 33.2 |
| 23 | 2 | 60 | 91.6736 | 57.8053 | 65.0844 | 21.5 |
| 24 | 2 | 60 | 91.6691 | 53.4608 | 64.4797 | 28.8 |
| Ave. | 2 | 60 | | | | 27.8 |

| | Average % Cleaning at Time (/s) | | | | | % Diff. at |
|---|---|---|---|---|---|---|
| Formula | 0 | 15 | 30 | 45 | 60 | 30 s |
| 1 | 0.0 | 45.8 | 61.7 | 76.6 | 69.3 | 406.1 |
| 2 | 0.0 | 9.3 | 15.2 | 18.3 | 27.8 | 24.6 |

### Example 3

Calorimetry Tests

Two samples were synthesised; one as per Components A and B of Example 1, the other as per Components A and B of Example 1 but without the sodium tungstate dihydrate catalyst of Component A of Example 1.

The pH and temperature of a 25g sample of Component A was recorded. The pH probe was then removed. Then, 25g of Component B was added to Component A and a timer was started. The mixture formed was swirled for 5 seconds and then the temperature was recorded at 15 seconds, 30 seconds and then every 30 seconds thereafter for 4 minutes. The mixture was then allowed to cool to room temperature, at which point the final pH measurement was taken.

The results are shown in Table 3 and FIG. 2 of the accompanying drawings. Both samples show a similar heat profile, however the sample containing the sodium tungstate dihydrate catalyst in Component A reaches an elevated temperature before the sample containing no catalyst. Moreover, the catalysed sample has a lower final pH value, i.e., a final pH value closer to neutral pH, even from a slightly higher initial pH value than the uncatalysed sample.

TABLE 3

| Catalyst | Temperature (/° C.) at Time (/s) | | | | | | | | | | pH | |
|---|---|---|---|---|---|---|---|---|---|---|---|---|
| (wt %) | 0 | 15 | 30 | 60 | 90 | 120 | 150 | 180 | 210 | 240 | Initial | Final |
| 0.02 | 23 | 35 | 65 | 70 | 69 | 68 | 66 | 65 | 63 | 62 | 12.07 | 9.18 |
| 0.00 | 24 | 31 | 58 | 71 | 70 | 68 | 67 | 65 | 64 | 63 | 11.97 | 9.40 |

Comparative Example 1 (Formula 2) showed no temperature rise over time.

A further example was synthesised; in this case the only difference to Components A and B of Example 1 was that the level of sodium tungstate dihydrate catalyst used was 0.05 wt % of Component A, rather than 0.02 wt %.

A similar calorimetry test was run on the 0.05 wt % catalyst formulation, with all other details as above. The results are shown in Table 4 and FIG. 3 of the accompanying drawings (comparison is given with the no catalyst formulation). Once again, the sample containing the sodium tungstate dihydrate catalyst in Component A reaches an elevated temperature before the sample containing no catalyst. Indeed, this effect is still more pronounced than in the case of the 0.02 wt % catalyst formulation above. Moreover, the 0.05 wt % catalyst sample has a lower final pH value, i.e. a final pH value closer to neutral pH, than either the uncatalysed sample or that containing 0.02 wt % catalyst in Component A.

TABLE 4

| Catalyst | Temperature (/° C.) at Time (/s) | | | | | | | | | | pH | |
|---|---|---|---|---|---|---|---|---|---|---|---|---|
| (wt %) | 0 | 15 | 30 | 60 | 90 | 120 | 150 | 180 | 210 | 240 | Initial | Final |
| 0.05 | 23 | 45 | 70 | 71 | 70 | 69 | 67 | 66 | 65 | 63 | 11.90 | 8.81 |
| 0.00 | 24 | 31 | 58 | 71 | 70 | 68 | 67 | 65 | 64 | 63 | 11.97 | 9.40 |

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A product comprising separate first and second compartments, the first compartment containing a first component of a composition in a stable environment, the second compartment containing a second component of the composition in a stable environment, wherein one of the components comprises a catalyst for a reaction between the first and second components, wherein, in use, the said two components are combined together to form said composition, and wherein the temperature of said composition is elevated when compared to the temperature of the components prior to said combination.

2. A product as claimed in claim 1 wherein the composition is a cleaning composition.

3. A product according to claim 1 wherein the temperature of the said composition formed is elevated by at least 5° C. when compared to the temperature of the components prior to said combination.

4. A product as claimed in claim 3 wherein said temperature elevation is at least 20° C.

5. A product as claimed in claim 3 wherein said temperature elevation is at least 30° C.

6. A product according to claim 1 wherein both of said components are liquid.

7. A product according to claim 1 wherein one of the said first and second components comprises an oxidising agent, whilst the other of the said first and second components comprises a reducing agent.

8. A product as claimed in claim 7 wherein said oxidising agent is a peroxide.

9. A product according to claim 7 wherein said oxidising agent is hydrogen peroxide.

10. A product according to claim 7 wherein said oxidising agent is present in the range of 4 to 7 wt % of the component.

11. A product according to claim 7 wherein said reducing agent is a thiosulfate.

12. A product according to claim 7 wherein said reducing agent is sodium thiosulfate.

13. A product according to claim 7 wherein said reducing agent is present in the range of 4 to 7 wt % of the component.

14. A product according to claim 7 wherein the catalyst is in the component comprising the reducing agent and the catalyst is capable of catalysing the redox reaction between the reducing agent and the oxidising agent in the other compartment of the product.

15. A product according to claim 7 wherein the catalyst is a tungstate compound.

16. A product as claimed in claim 15 wherein the tungstate compound is sodium tungstate, preferably sodium tungstate dihydrate.

17. A product according to claim 14 wherein the catalyst is present in the range 0.01 to 0.5 wt % of the component comprising the reducing agent.

18. A product according to claim 1 wherein at least one component further comprises at least one surfactant and/or emulsification aid, preferably in the component comprising a reducing agent.

19. A product as claimed in claim 18 wherein said at least one surfactant and/or emulsification aid is present in the range 0.5 to 2.5 wt %, preferably 0.6 to 2.1 wt % of the component comprising a reducing agent.

20. A product according to claim 1 wherein at least one component comprises a base.

21. A product as claimed in claim 20 wherein said base is present in the component comprising a reducing agent.

22. A product as claimed in claim 21 wherein said base is present in the range 3 to 10 wt %.

23. A method for cleaning a surface comprising the steps of:
i) combining the first and second components of the product on the surface to be cleaned to form the composition according to claim 1 wherein the temperature of the composition is elevated when compared to the temperature of the components prior to the combination,
ii) cleaning of the surface with the composition by wiping, rubbing or allowing the composition to remain in contact with the surface for a length of time, and
iii) substantially removing the composition from the surface.
